(19) United States
(12) Patent Application Publication
(10) Pub. No.: US 2014/0081712 A1
(43) Pub. Date: Mar. 20, 2014

(54) SUPPORTABILITY PERFORMANCE INDEX

(71) Applicants: Veit Eska, Malsch (DE); Oliver Kapaun, Bad Soden (DE)

(72) Inventors: Veit Eska, Malsch (DE); Oliver Kapaun, Bad Soden (DE)

(21) Appl. No.: 13/620,149

(22) Filed: Sep. 14, 2012

(51) Int. Cl. G06Q 10/06

(52) U.S. Cl. 705/7.39

(57) ABSTRACT

Methods and apparatus, including computer program products, are provided for determining a supportability index. In one aspect, there is provided a computer-implemented method. The method may include receiving metadata including information representative of one or more modules used by a manager providing lifecycle support to a business system; receiving at least one rule from a rules template, the at least one rule representative of a process to perform a calculation to determine a score; and calculating, based on the received metadata and the received at least one rule, the score representative of an amount of lifecycle support the manager including the one or more modules provide to the business system. Related apparatus, systems, methods, and articles are also described.

### FIELD

The present disclosure generally relates to data processing and, in particular, scoring supportability.

### BACKGROUND

A business system, such as enterprise resource planning system and the like, may include dozens if not hundreds of components, to form the aggregate system. Moreover, the business system may include a manager (also referred to as a life cycle manager) to support, operate, and monitor the business system and connected business systems in an integrated way. The manager may include components to enable management of the business system.

### SUMMARY

In one aspect there is provided a method. The method may include receiving metadata including information representative of one or more modules used by a manager providing lifecycle support to a business system; receiving at least one rule from a rules template, the at least one rule representative of a process to perform a calculation to determine a score; and calculating, based on the received metadata and the received at least one rule, the score representative of an amount of lifecycle support the manager including the one or more modules provide to the business system.

In some implementations, the above-noted aspects may further include additional features described herein including one or more of the following. A page including the score may be generated. The page may include the one or more modules, an indication of whether each of the one or more modules is currently being used, a scaling factor for each of the one or more modules, a sub-score for each of the one or more modules, and a graphical element representing a trend for a plurality of calculated scores. The score may be calculated as a sum of one or more sub-scores calculated for the one or more modules. The one or more sub-scores may be calculated based on a scaling factor and a support level. The scaling factor may represent an effectiveness to improve the amount of lifecycle support, and the support level may represent a contracted level of support.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

In the drawings,

FIG. 1 depicts an example of a page including a supportability performance index;

FIG. 2 depicts an example system for determining a supportability performance index;

FIG. 3 depicts an example process for determining a supportability performance index;

FIG. 4 depicts another example of a system for determining a supportability performance index; and

FIG. 5 depicts another example process for determining a supportability performance index.

Like labels are used to refer to same or similar items in the drawings.

### DETAILED DESCRIPTION

The subject matter described herein relates to determining an indicator of the supportability of a business system. In some example implementations, the indicator may comprise a Supportability Performance Index (SPI) as disclosed herein. In some example implementations, the SPI provides an indication of how well a manager of the business system provides support to the business system. For example, the manager of the business system may include one or more modules for managing the supportability of the business system during its lifecycle. The SPI may be used to assess the effectiveness of the manager including the one or more modules.

The SPI index may also provide an indication of how supportable a business system is in comparison to other business systems. For example, when a manager (also referred to herein as a management system) of a business system includes very few, ineffective, or rarely used management modules (also referred to herein as components, scenarios, tools, and the like), the supportability may be poor, when compared to a manager having numerous, robust, and effectively used management components. In this example, the manager having numerous, robust, and effectively used components may have a higher SPI score, when compared to a manager having very few, ineffective, and/or rarely used management components. As such, the SPI score may be used to assess the effectiveness of the manager providing lifecycle support to the business system.

In some implementations, the SPI score may be used to provide a user with an indication of how well the manager of the business system is supporting the associated business system. For example, if an end-user contracts for a given service level, this end-user may assess its SPI score at the contracted level to determine whether to change the contracted level of support. The SPI score may also provide insight into which components are being, or should be, used by the manager. Moreover, the SPI score may be used to perform “what if” analysis to see whether changes to the types, or quantity of, components at the manager affect the SPI score. For example, a manager may add a component, such as a business process monitor, and that addition may change (e.g., increase) supportability and the corresponding SPI score.

In some example implementations, the SPI score may also allow benchmarking by allowing comparison of SPI scores to a reference SPI score, such as previously determined SPI scores and/or SPI scores of other business systems (e.g., in which case a third-party, such as the developer of the manager of the business system may share metadata representative of the benchmark or the reference SPI scores). The benchmarking may also include establishing a target SPI score for a given system. This target SPI score for the manager of the business system (also referred to as manager and/or business system manager) may be determined based on scores determined from one or more business system managers of third-party systems or from prior scores of the business system.

In some implementations, the manager may, as noted, determine the SPI as a score, which may be a numerical score, a scaled score within a range (e.g., A-F, 1-10, etc.), or any other way to represent quantitatively or qualitatively a measure of supportability.

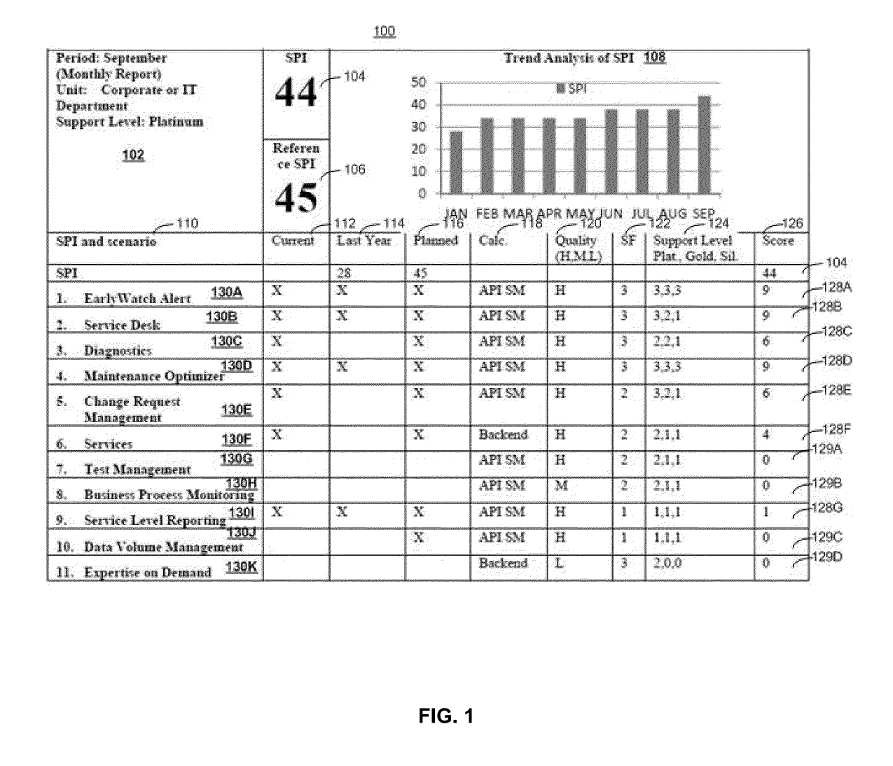

FIG. 1 depicts an example page 100 generated by the manager for a given business system.

The page 100 may include a header 102 including information representative of a period (e.g., “Monthly”) over which the SPI score is calculated, an identifier identifying the end-user (e.g., “Corporate or IT Department”) of page 100, and a support level representative of a certain service level contracted by the end-user (e.g., “Platinum”).

Page 100 may include a SPI score 104 and a reference SPI score 106. The manager may determine the SPI score 104 and a reference SPI score 106 based on input data, such as a contracted support level, a scaling factor, and the like as described further below.

Page 100 also depicts a graphical element 108 showing any trends in the SPI score over a certain period, which in this example is 9 months, although other periods may be used as well. The time period of the graphical element 108 may be selected by a user of the manager.

Page 100 may also include SPI scenarios 110. The SPI scenarios represent a component, such as a tool, a component, and the like, included in the manager to manage the life cycle of the business system. In some example implementations, these scenarios may include one or more of the following components (although other components may be used as well): an early watch alert 130A, service desk 130B, diagnostics 130C, maintenance optimizer 130D, change request management 130E, services 130F, test management 130G, business process management 130H, service level reporting 130I, data volume management 130J, and expertise on demand 130K, although other types of components/tools may be used as well.

In some implementations, the types of components may vary based on the service contracted for by the end-user. For example, a so-called “Platinum” life cycle service may be defined as the highest level of contracted service support and may dictate that the manager include a certain set of components, while a lesser service may have fewer or a different set of components.

In some implementations, the manager may also include components for reporting, such as a central system administration component, a system monitoring component, a business process monitoring component, and a service level reporting component.

In some implementations, the manager may also include an issue management component for tracking issues, such as bugs, an expertise on demand component for providing knowledge, an onsite service delivery component, a self services component, a solution reporting component, a business intelligence reporting component, a change request component, a maintenance optimizer component, a quality gate management component, a service desk messaging component, an implementation project component, an upgrade project component, a template project component, a maintenance project component, a test management component, an electronic learning management component, a customizing synchronization component, a project comparison component, a business process change analyzer component, a diagnostics component, a work centers used component, a custom code management cockpit component, a service connections component, and the like.

In some implementations, the early watch alert service 130A may be configured to provide a diagnostic service to monitor business processes and systems. The early watch alert service 130A may include information about system stability (e.g., availability, central processing unit and memory utilization, number of dumps, and the like) in the system being monitored. Furthermore, the early watch alert service 130A may be configured as a prerequisite for service level reporting as well as remote and onsite services. The service desk 130B may be configured to complete messages and forward the messages to another entity (e.g., a third party solution provider) for fulfillment of the service. Diagnostics component 130C may be configured to allow monitoring of components, such as JAVA components, in the system being monitored, and diagnostics component 130 may also be provide root cause analysis for failures, errors, or other issues. The maintenance optimizer 130D may provide an overview of maintenance activities in the system landscape. The maintenance optimizer 130D may accessed by an end-user to plan, download, and implement support package stacks, which contain a set of support packages for managed systems within a system landscape. Change request management 130E may be configured to manage projects, such as maintenance, implementation, templates, and upgrades. For example, the change management process may include change management, project planning, resource management, cost control, transports of changes from a development system to a production system, and the like.

Page 100 may also include a column for current 112 indicating which scenarios (as indicated by, for example, the “X”) are currently installed and in use (as indicated by the “X”) at the manager. In the example of page 100, the current 112 components being used by the manager include early watch alert 130A, service desk 130B, diagnostics 130C, maintenance optimizer 130D, change request management 130E, services 130F, and service level reporting 130I. These components may be used by the manager to support the lifecycle maintenance of the business system.

Moreover, page 100 may include a column for last year 114 indicating components that were previously used (as indicated by, for example, the “X”) but in order to increase supportability, other necessary scenarios, such as those indicated by an “X” in the current 112 column, may need to be activated and used. The usage of the other scenarios in the current column 112 may lead to a higher SPI. In the example of page 100, the last year 114 components include early watch alert 130A, service desk 130B, maintenance optimizer 130D, and service level reporting 130I. The SPI in this example is 28 (see, e.g., row SPI, column last year at FIG. 1). Page 100 may also include a column for planned 116 indicating ° that a component may, or will be, installed at the manager (as indicated by, for example, the “X”). In the example of page 100, the planned 112 components include early watch alert 130A, service desk 130B, diagnostics 130C, maintenance optimizer 130D, change request management 130E, services 130F, service level reporting 130I, and data volume management 130J. The SPI in this example is 45 (see, e.g., row SPI, column planned at FIG. 1).

The columns current 112, last year 114, and planned 116 provide information to allow determining what components have been, are being, or might be used by the manager to manage the lifecycle of the business system. Moreover, columns current 112, last year 114, and planned 116 may be used to perform analysis of past, current, and planned SPI by allowing SPI score calculations for each of the set of components corresponding to current 112, last year 114, and planned 116 and comparing the SPI scores for past, current, and planned.

The page 100 may also include a calculation column 118 (labeled “Calc”). The calculation 118 column may provide information regarding an origin of the data used to calculate the SPI score. This column may provide the details regarding how the numbers in the columns current 112 and last year 114 have been determined. For example, if the calculation column 118 includes API, the API indicator represents that metadata was obtained directly by accessing the API of a component. SM represents that the metadata was obtained from a lifecycle management system, and backend represents that metadata was obtained from a third party, such as provider or developer of the manager, component/scenario, or business system, which acts as a backend system. The backend system may be a third party software, such as the software of a third party solution provider.

The column scaling factor (SF) 122 represents a scaling factor used to weigh the importance of a component, such as components 130A-K, in determining the SPI. For example, the early watch alert 130A component may be configured to have a scaling factor of 3 (which is the highest value in the current example), while the data volume management 130J component may have a scaling factor of 1. In this example, the early watch alert 130A component (or scenario) is more effective and may be considered more important for determining (e.g., predicting, estimating, calculating, etc.) the SPI score, when compared to the data volume management 130J component. A reason is that the early watch alert 130A may be configured as a prerequisite before using other components. In some implementations, the scaling factors may be defined by a template having one or more rules defining how to calculate the SPI. For example, a new scenario may be added as new developments and new business scenarios are considered. When a new scenario is added to the manager, the new scenario would require a corresponding calculation method 118, quality indicator 120, scaling factor 122, and support level relevance 124 to allow calculation of the SPI.

Page 100 may also include a support level 124 column representative of the level of support contracted by the end-user of the manager for which the SPI is being calculated. The level of support may represent the level contracted by a given user. The levels may be defined to have specific support requirements, and may include labels, such as silver, gold, platinum and the like to indicate higher or lower service levels. In some implementations, each service levels may define a certain set of scenarios.

In the example of page 100, the SPI score is 44. The manager may calculate the score based on the sub-scores in the last column 128A-G. For example, there are 7 components at rows 1-6 and 9 that are currently in use (as shown by current column 112 and their sub-scores 128A-G). The sub-score value of 9 128A at the first row and last column is determined by multiplying the scaling factor 3 by the support level value 3 to determine a score of 9 at 128A. The manager performs similar calculations at rows 2-6 and 9 (128B-G), and then sums each of the sub-scores 128A-G in the last column (e.g., 9, 9, 6, 9, 6, 4, and 1) to determine the SPI score of 44. In this example, the reference SPI of 45 represents a benchmark or a reference SPI score determined at the beginning of a period being evaluated. The target and planned SPI in the example of page 100 is 45 (see, e.g., row SPI, column planned 116 in FIG. 1.) The objective in this example is to reach the benchmark. However, it can be also the objective to outperform the benchmark. Moreover, using a different support contract, such as Gold or Silver, may result in a different score, as the support level value would change from 3 to another lesser value, such as 2, 1, or even 0. In row 11, the value may be configured as 0 for lower support levels since the scenario is not available for both lower support levels (e.g., Silver and Gold). In this example, the different values are result of the different, assigned importance values. In some cases, the scenarios in rows 2, 3, 5, 6, 7 or 8 may be prerequisites for scenarios in higher-level support levels, which is reflected in the main scenario mentioned for example on page 100. This may lead to different factors representing the importance of the scenarios for the support level.

The SPI score 44 (at 104) may thus represent how well the manager is providing life cycle maintenance to the business system given the set of components being used by the manager and/or the support level being used. The SPI score is the overall total sum of all sub scores (e.g., 128A, 128B, 128C, 128D, 128E, 128F, 128G).

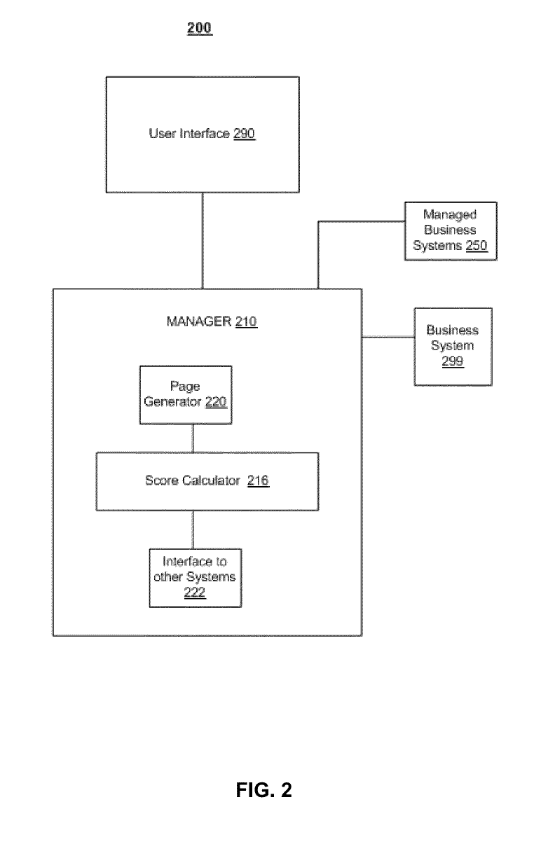

FIG. 2 depicts an example of a system 200 for determining a SPI score. The system includes a user interface 290, a manager 210, and a business system 299, which may be coupled by a communication mechanism(s). The business system 299 may be implemented as an enterprise resource system, although other types of business systems may be used as well. The business system may act as a so-called “backbone system.”

In some implementations, the user interface 290 may be implemented as a browser, smart client, and/or any other interface to allow access to manager 210. User interface 290 may also present pages, such as hypertext markup language pages and the like, for viewing by a user, although other types of pages may be used as well.

The manager 210 may be implemented to manage the life cycle maintenance of managed business systems 250. The manager 210 may include a page generator 220 for generating pages, such as page 100, a score calculator 216 for determining an indication, such as SPI, and an interface to other business systems 222 to obtain metadata regarding supportability. The managed business systems 250 may, in some implementations, be separate from manager 210. In some implementations, business system 299 may be configured to provide a central backbone system where the template definition is sourced and distributed to one or more managers 210. This template definition may include rules and information for calculating the SPI and may include one or more of the reference SPI 106, scenarios 130A . . . 130K, the method for determining the scenario usage 118, the scaling factor 122, the support level weight 124, and the quality information 120, and the like.

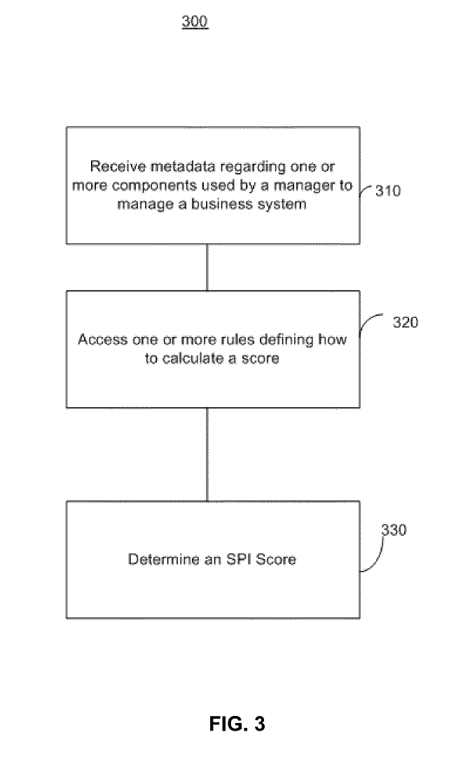

FIG. 3 depicts a process 300 for determining an SPI score, in accordance with some example implementations. The description of process 300 also refers to FIG. 2.

At 310, manager 210 may receive metadata representative of one or more components used by the manager 210 to manage the life cycle maintenance of business system 250. The metadata as well as the rules how to measure and receive data may be defined by a template (also referred to herein as a template definition) in the backbone system of the software vendor or the solution provider 299. For example, manager 210 may receive metadata indicating that the following components are being used: an early watch alert 130A, service desk 130B, diagnostics 130C, maintenance optimizer 130D, change request management 130E, services 130F, and service level reporting 130I. The metadata may also include contracted support level information, which is available at the software or solution provider.

At 320, manager 210 may access a template including one or more rules defining how to calculate the SPI score given the metadata received at 310. For example, a template may define that the SPI score 44 is a sum of sub-scores 128A-G and 129A-D. Moreover, these sub-scores may each be calculated based on a scaling factor and a support level (e.g., as a product of the scaling factor 122 and the support level 124 contracted for by the user of manager 210). The score may depend on the template definition. The template definition may define how to receive metadata 118. The quality 120 may be implemented as an indicator for the quality of the received metadata 118. For example, the EarlyWatch Alert 130A may be set to ‘X’ for 112, 114 and 116 because managed business systems 250 are managed by manager 210 and the service is active and running.

At 330, manager 210 may determine the SPI score based on the template. For example, score calculator 216 may calculate the sub-scores 128A-G and 129A-D, and then sum the sub-scores 128A-G and 129A-D to determine the SPI score 44. The manager 210 may also provide the score to the page generator 220 to allow generation of page 100.

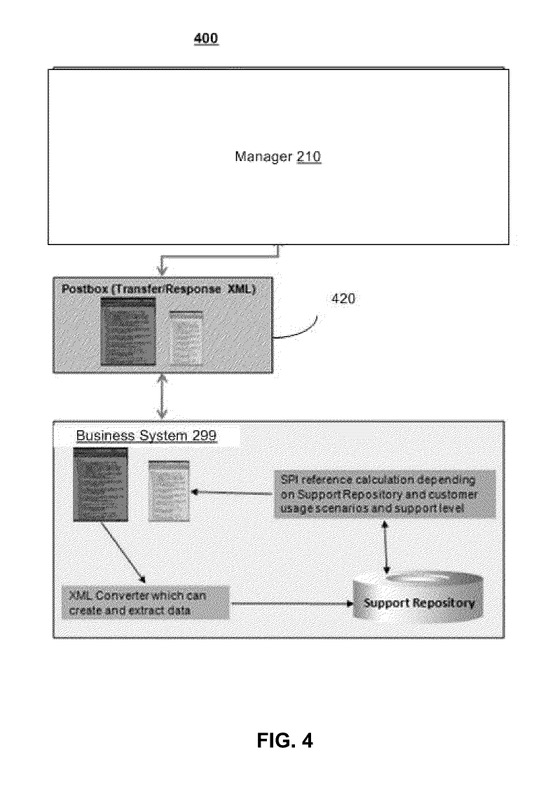

FIG. 4 depicts system 400 including lifecycle manager 210, a communication interface 420 for exchanging the SPI scores and other information with a business backbone system 299.

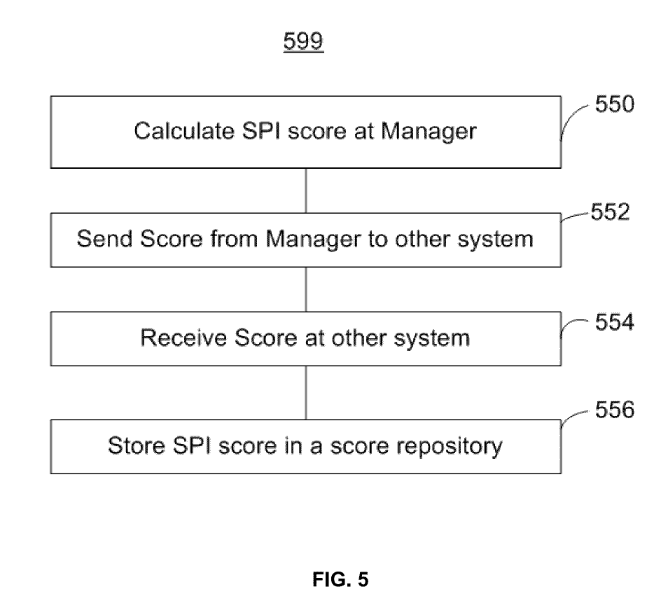

FIG. 5 depicts an example process 500 for calculating the SPI score in connection with system 400. At 550, an SPI score is calculated by manager 210. At 552, the calculated SPI score may then be converted into an XML file and then sent to the central business backbone system 299 via a communication interface 420 (e.g., as a message and the like). At 554, the SPI score may then received at business backbone system 299 as, for example, a message, and then stored, at 556, in a score repository for additional analysis and historical information (e.g., to allow benchmarking and calculation of the reference SPI 106).

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions. As used user herein, module may refer to at least one of a computer program or a portion thereof stored in at least one memory and executed by at least one processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Although a few variations have been described in detail above, other modifications are possible. For example, while the descriptions of specific implementations of the current subject matter discuss analytic applications, the current subject matter is applicable to other types of software and data services access as well. Moreover, although the above description refers to specific products, other products may be used as well. In addition, the logic flows depicted in the accompanying figures and described herein do not require the particular order shown, or sequential order, to achieve desirable results. As used herein, the term “based” may also comprise “based on at least.” Other embodiments may be within the scope of the following claims.

What is claimed:

1. A non-transitory computer-readable medium containing instructions to configure at least one processor to perform operations comprising:
receiving metadata including information representative of one or more modules used by a manager providing lifecycle support to a business system;
receiving at least one rule from a rules template, the at least one rule representative of a process to perform a calculation to determine a score; and
calculating, based on the received metadata and the received at least one rule, the score representative of an amount of lifecycle support the manager including the one or more modules provide to the business system.

2. The computer-readable medium of claim 1 further comprising:
generating a page including the score.

3. The computer-readable medium of claim 2, wherein the page includes the one or more modules, an indication of whether each of the one or more modules is currently being used, a scaling factor for each of the one or more modules, a sub-score for each of the one or more modules, and a graphical element representing a trend for a plurality of calculated scores.

4. The computer-readable medium of claim 1, wherein the calculating further comprises:
calculating the score as a sum of one or more sub-scores calculated for the one or more modules.

5. The computer-readable medium of claim 1, wherein the one or more sub-scores are calculated based on a scaling factor and a support level.

6. The computer-readable medium of claim 5, wherein the scaling factor represents an effectiveness to improve the amount of lifecycle support, and wherein the support level represents a contracted level of support.

7. A method comprising:
receiving metadata including information representative of one or more modules used by a manager providing lifecycle support to a business system;
receiving at least one rule from a rules template, the at least one rule representative of a process to perform a calculation to determine a score; and
calculating, based on the received metadata and the received at least one rule, the score representative of an amount of lifecycle support the manager including the one or more modules provide to the business system, wherein the manager and the business system comprise at least one processor and at least one memory.

8. The method of claim 7 further comprising:
generating a page including the score.

9. The method of claim 8, wherein the page includes the one or more modules, an indication of whether each of the one or more modules is currently being used, a scaling factor for each of the one or more modules, a sub-score for each of the one or more modules, and a graphical element representing a trend for a plurality of calculated scores.

10. The method of claim 7, wherein the calculating further comprises:
calculating the score as a sum of one or more sub-scores calculated for the one or more modules.

11. The method of claim 7, wherein the one or more sub-scores are calculated based on a scaling factor and a support level.

12. The method of claim 11, wherein the scaling factor represents an effectiveness to improve the amount of lifecycle support, and wherein the support level represents a contracted level of support.

13. A system comprising:
at least one processor; and
at least one memory including code which when executed by the at least one processor provides operations comprising:
receiving metadata including information representative of one or more modules used by a manager providing lifecycle support to a business system;
receiving at least one rule from a rules template, the at least one rule representative of a process to perform a calculation to determine a score; and
calculating, based on the received metadata and the received at least one rule, the score representative of an amount of lifecycle support the manager including the one or more modules provide to the business system.

14. The system of claim 13 further comprising:
generating a page including the score.

15. The system of claim 14, wherein the page includes the one or more modules, an indication of whether each of the one or more modules is currently being used, a scaling factor for each of the one or more modules, a sub-score for each of the one or more modules, and a graphical element representing a trend for a plurality of calculated scores.

16. The system of claim 13, wherein the calculating further comprises:
calculating the score as a sum of one or more sub-scores calculated for the one or more modules.

17. The system of claim 13, wherein the one or more sub-scores are calculated based on a scaling factor and a support level.

18. The system of claim 17, wherein the scaling factor represents an effectiveness to improve the amount of lifecycle support, and wherein the support level represents a contracted level of support.
